(19) United States
(12) Patent Application Publication
(10) Pub. No.: US 2008/0256491 A1
(43) Pub. Date: Oct. 16, 2008

(54) INFORMATION-PROCESSING APPARATUS AND INFORMATION-PROCESSING METHOD

(75) Inventor: Eriko Ozaki, Hachioji-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/059,623

(22) Filed: Mar. 31, 2008

(30) Foreign Application Priority Data
Apr. 13, 2007 (JP) 2007-106135

(51) Int. Cl. G06F 3/048

(52) U.S. Cl. 715/838; 715/846

(57) ABSTRACT

An apparatus generates operation-history information including content-group information relating to a content group and operation information relating to the content group, and stores the operation-history information in a storage unit. The apparatus determines, when a content is selected, whether the operation-history information stored in the storage unit includes operation-history information including content-group information relating to a group including the selected content, and displays a GUI component including the content-group information included in the operation-history information and the operation information when it is determined that the operation-history information including the content-group information relating to the group including the selected content exists.

### BACKGROUND OF THE INVENTION

1. Field of the Invention

The present invention relates to an apparatus and a method for processing and utilizing history information relating to data such as image data and text data.

2. Description of the Related Art

Due to technological advances, it is possible for users to easily access multimedia contents that include not only text data, but also data on still images, video, etc. Additionally, the capacities of storage devices storing such multimedia contents as file data have increased significantly. As a result, technological improvements to facilitate finding and retrieving desired file data from a large amount of stored file data of various types are desirable.

When making a search for file data, the search may be narrowed down based on an attribute, etc. of the file data. However, since file data used with a high frequency is likely to be used repeatedly in the future, there have been methods of providing information about the history of operations performed for the file data, as a search condition. For example, Japanese Patent Laid-Open No. 2005-18734 discloses a technology to retrieve desired file data based on the history of operations performed for the desired file data.

Further, mechanisms for explicitly storing information about the operation history as a bookmark, a favorite, a tag, etc. by a user, the mechanisms being used when it is estimated that the same file data is used next time, are widely known. According to the above-described mechanisms, it is possible to find file data previously used by accessing the bookmark, the favorite, the tag, etc. when the next operation is performed.

However, if a user wishes to use information about the history of operations performed for a plurality of file-data items according to the above-described known methods, the file-data items should be narrowed down by making a search based on the operation history, for example. Therefore, if an arbitrary file-data item is selected from among file-data items for which operations are performed, it is difficult for the user to easily reuse a combination of file-data items other than the selected file-data item.

Further, since the operation-history information should be stored explicitly, it is difficult for the user to store the operation-history information. Subsequently, the operation-history information is rarely stored with stability. Therefore, as is often the case, the operation-history information is not stored even though the user wishes to use the same file as the file for which an operation was previously performed.

### SUMMARY OF THE INVENTION

According to an embodiment of the present invention, when a file-data item is selected from among file-data items for which operations are performed, it becomes possible to easily reuse a combination of file-data items other than the selected file-data item even though a user does not explicitly stores information about the history of the selected file-data item.

According to an aspect of the present invention, an information-processing apparatus according to an embodiment includes an operation-history-information-storage unit configured to generate operation-history information including content-group information relating to a content group and operation information relating to the content group, and store the operation-history information in a storage unit, a determination unit configured to determine, when a content is selected, whether the operation-history information stored in the storage unit includes operation-history information including content-group information relating to a group including the selected content, and a display unit configured to display a Graphic User Interface (GUI) component including the content-group information included in the operation-history information and the operation information when the determination unit determines that the operation-history information including the content-group information relating to the group including the selected content exists.

A method according to another embodiment of the present invention includes generating operation-history information including content-group information relating to a content group and operation information relating to the content group, and storing the operation-history information in a storage unit, determining when a content is selected, whether the operation-history information stored in the storage unit includes operation-history information including content-group information relating to a group including the selected content, and displaying a GUI component including the content-group information included in the operation-history information and the operation information when it is determined that the operation-history information including the content-group information relating to the group including the selected content exists.

An embodiment of the present invention may be achieved by using a program and/or a recording medium.

Further features of the present invention will become apparent from the following description of exemplary embodiments with reference to the attached drawings, which are incorporated in and constitute a part of the specification, illustrate embodiments of the invention and, together with the description, serve to explain the principles of the invention.

### BRIEF DESCRIPTION OF THE DRAWINGS

FIG. 1 is a block diagram illustrating the configuration of an information-processing apparatus including a personal computer (PC), a computer, etc.

FIG. 2 shows an example image shown on a display unit.

FIG. 3 shows a first example GUI image shown on the display unit.

FIG. 4 is a flowchart showing example operations performed when a user selects an arbitrary combination of file data and an operation performed for the file data so that the operations are performed for the file data and information about history of the operations is automatically stored.

FIG. 5 is a flowchart showing example operations performed when the operation-history information is shown so that the user can reuse the file data.

FIG. 6 shows a second example GUI image shown on the display unit.

FIG. 7 shows an example GUI component shown on the display unit when the user selects an operation-reset button shown in FIG. 6.

FIG. 8 is a flowchart showing example operations performed to generate a GUI shown on the display unit when the user resets operations performed for target file data.

FIG. 9 is a block diagram showing the configuration of another information-processing apparatus including a PC, a computer, etc.

FIG. 10 is a flowchart showing example operations performed to show the operation-history information according to information about a user identified by a user-identification unit.

### DESCRIPTION OF THE EMBODIMENTS

Hereinafter, embodiments of the present invention will be described in detail with reference to the attached drawings.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-106135, filed on Apr. 13, 2007, which is hereby incorporated by reference herein in its entirety.

### First Embodiment

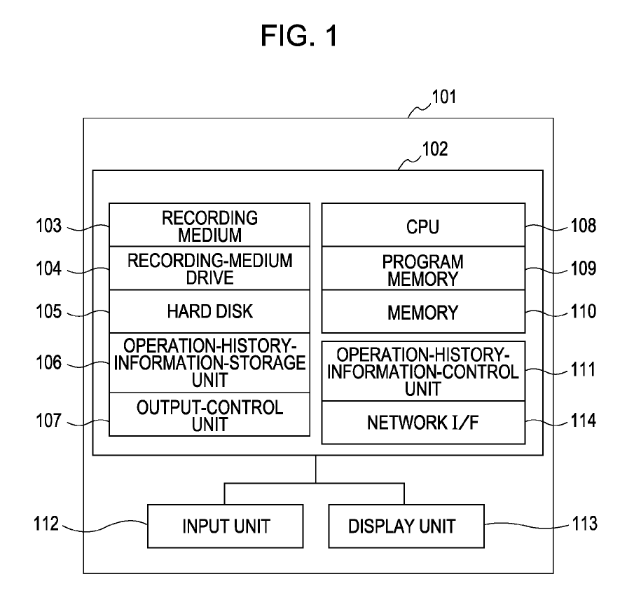

FIG. 1 is a block diagram showing the configuration of an information-processing apparatus 101 including a PC, a computer, etc. In FIG. 1, the information-processing apparatus 101 reads and reproduces data stored in a recording medium 103 by using a recording-medium drive 104. Further, the information-processing apparatus 101 can access data stored in a record device such as a hard disk (HD) 105, so as to reproduce the stored data.

An output-control unit 107 controls a display unit 113 so that the data is displayed on the display unit 113 in list form. The display unit 113 includes a cathode-ray tube (CRT), a liquid-crystal-display unit, a plasma-display unit, a surface-conduction electron-emitter display (SED), and so forth. The display unit 113 shows a GUI menu, various types of images, text data, and so forth on the basis of data transmitted from the output-control unit 107.

An input unit 112 has a pointing device including a keyboard, a mouse, etc. to input various types of commands and/or data according to an operation performed by a user. Further, a network interface (I/F) 114 transmits and/or receives information to and/or from peripheral devices connected to the information-processing device 101, and acquires information about functions of the peripheral devices and/or information about content data stored in the peripheral devices.

An operation-history-information-control unit 111 of the information-processing apparatus 101 manages the history of operations by generating information about the operation history and/or storing the generated operation-history information in an operation-history-information-storage unit 106. At the time where an operation of some kind is performed for file data (content data), an operation-history-information-management unit provided in the operation-history-information-control unit 111 associates target file data for the operation with information about details on the operation, and stores the target file data and the operation-detail information. Here, the file data may be provided, as data on part of and/or an entire single file-data item. For example, the file data may correspond to part of image data, a single page of text data, and so forth.

More specifically, after the user specifies the file data and requests an operation to be performed for the specified file data through the input unit 112, a central-processing unit (CPU) 108 performs the operation. At that time, the operation-history information is generated and stored in the operation-history-information-storage unit 106 without fail. The operation-history information includes information about the size and/or address (storage destination) of at least one file-data item specified by the user through the input unit 112, information about details relating to the operation that is requested by the user and that is performed for the at least one file-data item, information about the date and time when the operation is executed, etc.

Further, the operation-history-information-control unit 111 searches for the operation-history information stored in the operation-history-information-storage unit 106 and determines whether operation-history information relating to file data selected by the user exists.

Further, the operation-history-information-control unit 111 transmits information about an output to the output-control unit 107 to exhibit information about a group of operation files and operation information that relate to the currently selected file data based on information stored in the operation-history-information-storage unit 106. Additionally, when the user selects the operation information transmitted to the output-control unit 107 and an operation target through the input unit 112, the operation-history-information-control unit 111 performs the operation corresponding to the operation information.

The information-processing unit 102 at least includes the CPU 108, a program memory 109 storing a processing program executed by the CPU 108, and a memory 110 configured to provide a work area when the CPU 109 performs processing and temporarily store various types of data.

The functions of the output-control unit 107 and the operation-history-information-control unit 111 are achieved through collaboration between the processing program and the CPU 108. Further, the operation-history-information-storage unit 106 is achieved by the memory 110, the HD 105, etc. Further, the processing program may be installed in the HD 105 so that when the processing program is executed, the processing program is loaded from the HD 105 on a random-access memory (RAM) that is not shown and executed. The information-processing unit 102 also controls the input unit 112 and/or the display unit 113.

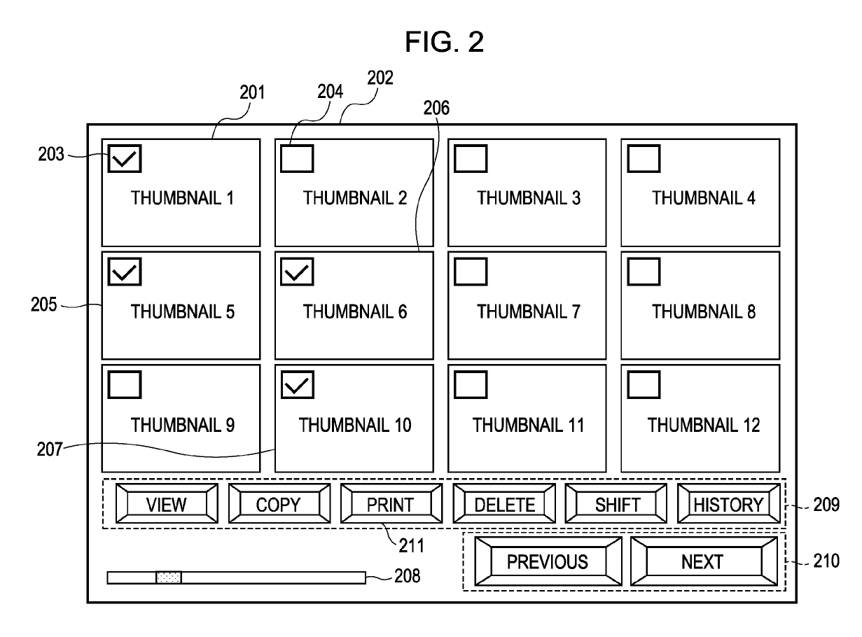

FIG. 2 shows an example image displayed on the display unit 113. Each of images 201, 202, 205, 206, and 207 is a reduced image of file data stored in the recording medium 103, the HD 105, a medium or the like inserted in a peripheral device connected to the information-processing apparatus 101 via a network or the like, etc.

The user can select the file data represented by the reduced image through the input unit 112 or the like. Further, the display unit 113 can also display the status of selection of file data (and/or a reduced image). In FIG. 2, for example, a field 203 shows the status of selection of the reduced image 201. A field 204 shows the status of non-selection of the reduced image 202. Namely, the field 203 shows an example where the reduced image 201 is selected. Likewise, according to FIG. 2, of twelve reduced images shown in list form, each of the reduced images 201, 205, 206, and 207 is selected by the user.

A field 208 denotes an indicator configured to indicate to which file data of the whole file data shown in the currently used display order the reduced images displayed in the list form on a display screen correspond. The indicator is also configured to show the ratio between the file data corresponding to the reduced images and the whole file data.

A field 209 shows example menu buttons showing details on operations that can be specified by the user through the input unit 112, as operations performed for the currently selected file data. A field 210 shows example page-feeding buttons used to switch between display images according to an instruction issued by the user through the input unit 112, so as to display file data that is not shown on the screen image, that is, file data prior to and/or subsequent to the currently shown file data.

Here, when a printing-execution button 211 is selected and specified by the user through the input unit 112, for example, the information-processing apparatus 101 performs processing relating to printing of file data indicated by the currently selected reduced images 201, 205, 206, and 207. At that time, the operation-history-information-control unit 111 performs processing relating to the printing and stores the operation-history information. In that case, the operation-history-information-control unit 111 generates a group of file data including a combination of file data indicated by the reduced images 201, 205, 206, and 207, and operation-history information wherein a printing operation is associated with the file-data group as the operation information. Namely, the operation-history information at least includes information about the file-data group (file-data-group information) and the operation information. The operation-history-information-control unit 111 stores and/or saves the generated operation-history information in the operation-history-information-storage unit 106.

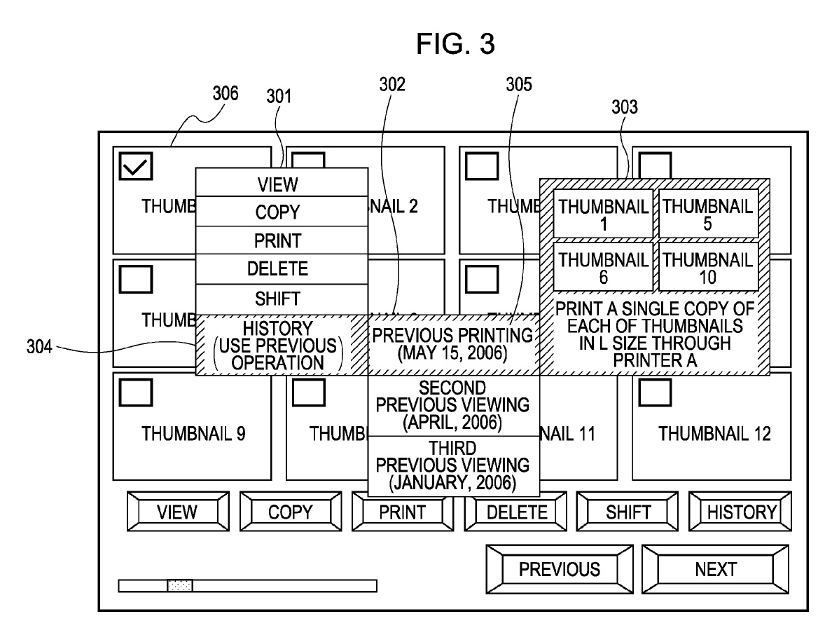

FIG. 3 is an illustration of a first example GUI image shown on the display unit 113. A field 301 shows an example context menu shown on the display unit 113, as a list of information about operations that can be performed when file data indicated by a reduced image 306 of file data shown in list form is selected by the user.

Further, a field 302 shows an example history menu shown on the display unit 113 when a menu 304 of the context menu 301 is selected by the user. According to FIG. 3, data items “the previous printing”, “the second previous viewing”, and “the third previous viewing” are shown, as examples of the history menu 304.

A field 305 shows, for example, information about the printing operations described in FIG. 2 is stored in the operation-history-information-storage unit 106, as the data “previous printing”. When the user selects the field 305, details on the operation information stored in the operation-history-information-storage unit 106 (a GUI component 303 exhibiting the details on the operation information) are displayed on the display unit 113. More specifically, the GUI component 303 includes the file-data-group information (and/or data on the reduced image of file data belonging to a file-data group relating to the file-data-group information) and the operation information that are included in the operation-history information. Here, every selection made by the user is achieved through the input unit 112. Here, the GUI component denotes each of components of a GUI shown on the display unit 113 (e.g., a screen image, a menu image, a button image, etc.).

Here, according to FIG. 3, the history menus show, for example, the position of an operation in the operation sequence and the time when the operation was performed. However, each of the history menus may simply show the operation information. That is, the history menus may take any form so long as they are helpful to use the operation-history information.

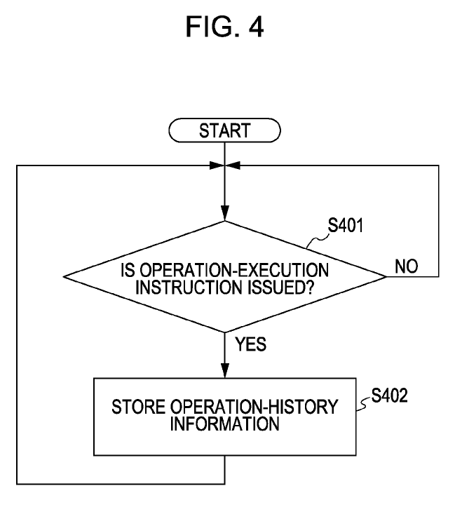

FIG. 4 is a flowchart showing example functions performed to execute operations for an arbitrary combination of file data and automatically store information about the history of the executed operations when the user selects the arbitrary file-data combination and the operations executed for the file-data combination.

At step S401, the operation-history-information-control unit 111 waits until the user issues an instruction to execute an operation of some kind through the input unit 112. If it is determined that the instruction is issued, the operation-history-information-control unit 111 advances to step S402. If it is determined that the instruction is not issued, the operation-history-information-control unit 111 performs the processing corresponding to step S401 again.

At step S402, the operation-history-information-control unit 111 generates the operation-history information based on the currently selected file data and information about the operation specified by the user, and stores the generated operation-history information in the operation-history-information-storage unit 106 (storage of the operation-history information).

After the processing corresponding to step S402 is finished, the operation-history-information-control unit 111 returns to step S401 and waits until the user issues the operation instruction. Here, the operation-history information is stored in the operation-history-information-storage unit 106 as the storage capacity of the operation-history-information-storage unit 106 allows. Therefore, when the storage capacity of the operation-history-information-storage unit 106 becomes insufficient to store the operation-history information, the oldest operation-history information of the operation-history information stored in the operation-history-information-storage unit 106 is overwritten.

As described above, the information-processing apparatus 101 automatically generates and saves the operation-history information when the user performs some operations. According to the example shown in FIG. 2, information about the combination of file data indicated by the reduced images 201, 205, 206, and 207, the information about the printing operations, information about the date and time where the printing operations are executed, etc. are stored in the operation-history-information-storage unit 106, as the operation-history information.

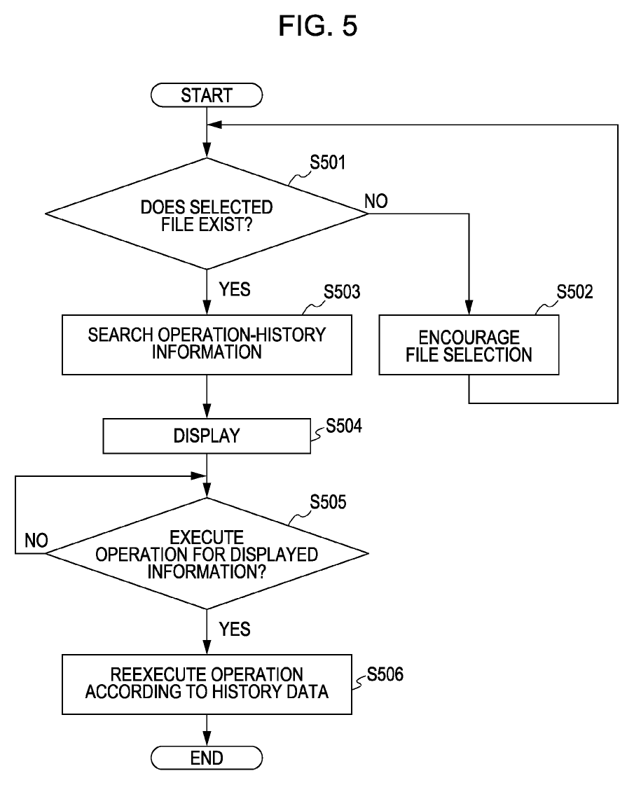

FIG. 5 is a flowchart showing example operations performed when the operation-history information is exhibited so that the user can reuse the file data. When being instructed to use the history information by the user through the input unit 112, the operation-history-information-control unit 111 determines whether the currently selected file data (selected file data) exists, at step S501. If it is determined that the selected file data exists, the operation-history-information-control unit 111 advances to step S503. If the selected file data does not exist, the operation-history-information-control unit 111 advances to step S502.

At step S502, the operation-history-information-control unit 111 displays information indicating “Please select file data.”, etc. on the display unit 113 or the like through the output-control unit 107 by using, for example, a dialog image to encourage the user to select file data. If no file data is selected, the operation-history-information-control unit 111 may display the entire operation-history information stored in the operation-history-information-storage unit 106 on the display unit 113 through the output-control unit 107. According to another embodiment, if no file data is selected, the operation-history-information-control unit 111 may disable the GUI buttons (and/or the history menus) shown on the display unit 113 to make it difficult to use the entire operation-history information stored in the operation-history-information-storage unit 106.

At step S503, the operation-history-information-control unit 111 searches the operation-history information stored in the operation-history-information-storage unit 106 and checks whether operation-history information relating to the selected file data exists (existence determination). That is to say, the operation-history-information-control unit 111 determines whether the operation-history information stored in the operation-history-information-storage unit 106 includes operation-history information including information about a filed-data group including the selected file data.

If the result of the search made at step S503 shows any operation-history information relating to the selected file data, the operation-history-information-control unit 111 shows information about operations performed by the last time and a combination of target file data for the operations on the display unit 113 via the output-control unit 107. On the other hand, if any operation-history information relating to the selected file data is not found, the operation-history-information-control unit 111 shows information indicating, for example, “there is no usable operation-history information related to the selected file” on the display unit 113 by using a dialog image or the like through the output-control unit 107. According to another embodiment, the operation-history-information-control unit 111 displays information about some of operations that are recently performed (and/or a combination of operations and file data) on the display unit 113 via the output-control unit 107, at step S504, based on the operation-history information stored in the operation-history-information-storage unit 106.

At step S505, the operation-history-information-control unit 111 waits until the user instructs to re-execute the operation corresponding to the operation-history information exhibited (and/or displayed) at step S504. Namely, the operation-history-information-control unit 111 waits until the user selects (and/or presses down) an execution button 603 illustrated in an embodiment described later. If it is determined that the user instructs to re-execute the operation through the input unit 112, the operation-history-information-control unit 111 advances to step S506. If it is determined that the user does not instruct to re-execute the operation, the operation-history-information-control unit 111 performs the processing corresponding to step S505 again.

At step S506, the operation-history-information-control unit 111 re-executes the operation corresponding to the operation information for the target file data included in the operation-history information.

When the user instructs to use the history information, as described above, the operation-history-information-control unit 111 (and the output-control unit 107) retrieves operation-history information desired by the user from the operation-history information stored in the operation-history-information-storage unit 106 and exhibits the desired operation-history information. FIG. 3 shows the example where operation information and a group of the operation-target-file data corresponding to the operation information are exhibited, as operation-history information relating to file data represented by the reduced image 306.

Here, if a plurality of file data items is selected, the operation-history-information-control unit 111 searches only for operation-history information including file-data-group information including all of the selected file-data items, at step S503. Subsequently, the information-processing apparatus 101 can display only operations performed for all of the selected file data items in common. Namely, the information-processing apparatus 101 can narrow down the operation-history information for display. At that time, the information-processing apparatus 101 may allow the user to select different file data after operation-history information relating to file data that had been selected once is displayed.

Thus, according to the first embodiment of the present invention, the user can easily use information about the history of operations that had been performed by the last time. Namely, the information-processing apparatus 101 can present a convenient GUI to the user.

### Second Embodiment

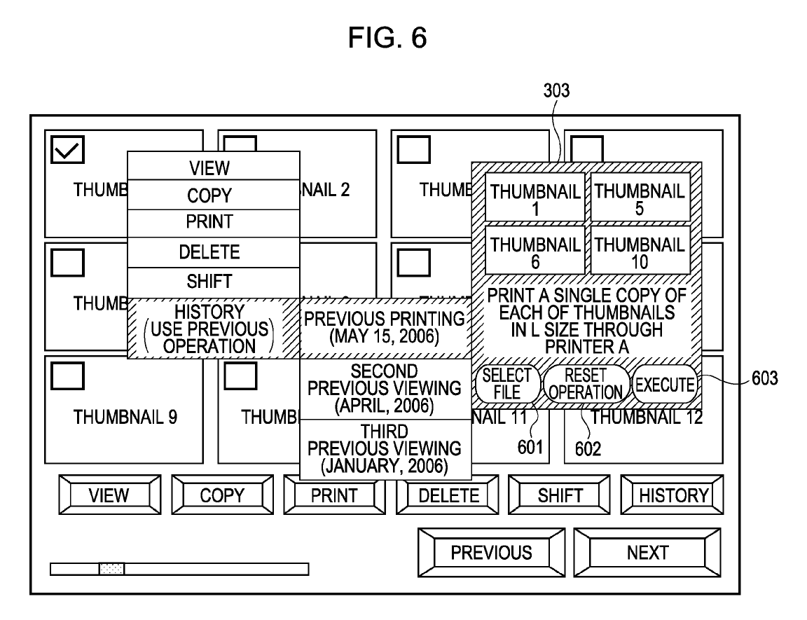

FIG. 6 is an illustration of a second example GUI image shown on the display unit 113. A field 601 shows a GUI button (file-reselection button) used to reset target file data. A field 602 shows a GUI button (operation-reset button) used to reset a target operation. A field 603 shows a GUI button (execution button) used to re-execute operations equivalent to those indicated by displayed operation-history information.

The output-control unit 107 shows, for example, a screen image (and/or a GUI image) shown in FIG. 6 on the display unit 113 at step S504 shown in FIG. 5.

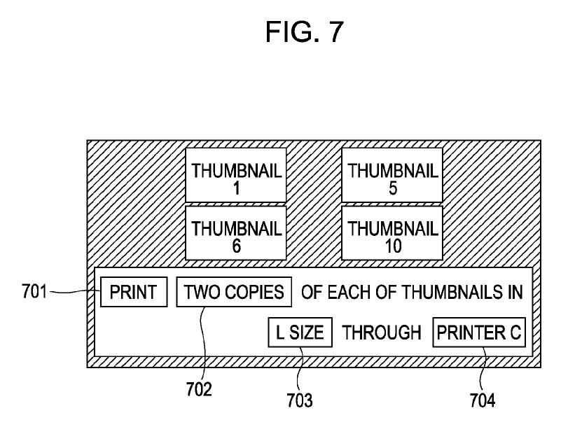

FIG. 7 shows an example GUI component shown on the display unit 113 when the user selects the operation-reset button 602 shown in FIG. 6. Since the previous operation is a printing operation according to the example shown in FIG. 7, a printer is set in a field 704, the number of copies is set in a field 702, and the form size is set in a field 703.

The user can set an operation item in a field 701 by using the input unit 112. Operations other than the printing operation may be viewing, copying, deletion, etc. If an operation other than the printing operation is selected in the field 701, the information-processing apparatus 101 can select an item appropriate for details on the selected operation in each of the fields 702 to 704.

Control processing or the like relating to FIG. 7 is performed by the output-control unit 107, the operation-history-information-control unit 111, etc.

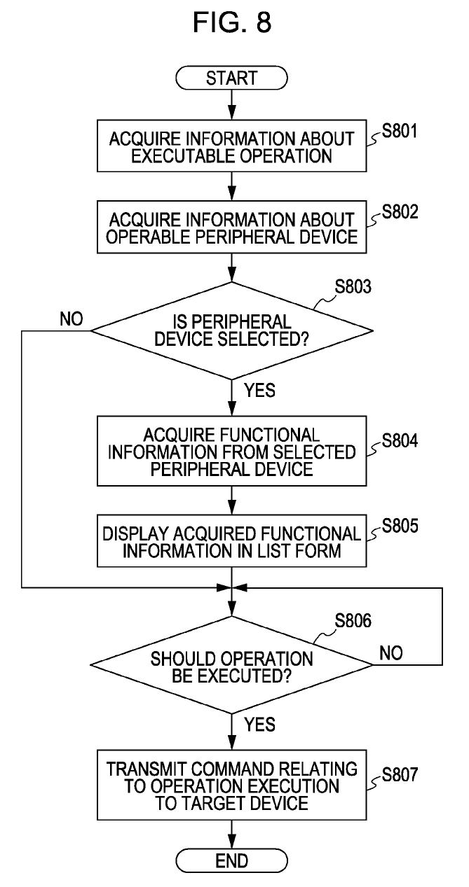

FIG. 8 is a flowchart showing, for example, operations performed to generate a GUI shown on the display unit 113 when the user resets an operation performed for target file data. For example, when the operation-reset button 602 shown in FIG. 6 is selected (and/or pressed down) by the user, the operation-history-information-control unit 111 acquires information about an operation that can be executed for an applicable file-data group (operation information), at step S801.

For example, on the basis of the applicable file-data-group information, the operation-history-information-control unit 111 determines whether file data belonging to the file-data group corresponding to the above-described file-data-group information is protection-target-file data, and determines whether a delete operation can be performed. Further, the operation-history-information-control unit 111 determines whether or not a viewing operation can be performed for the file data based on information about the attribute of the file data. Thus, the operation-history-information-control unit 111 determines (and/or acquires information about) an executable operation.

At step S802, the operation-history-information-control unit 111 acquires information about a peripheral device that is operable (and/or capable of conducting communications) via a network I/F 114, etc. Then, the operation-history-information-control unit 111 displays the entire acquired peripheral-device information on the display unit 113 via the output-control unit 107. Further, the operation-history-information-control unit 111 may display information about a peripheral device that can perform the operation corresponding to the operation information acquired at step S801 of the acquired peripheral-device information on the display unit 113.

At step S803, on the basis of operation data or the like transmitted from the user via the input unit 112, the operation-history-information-control unit 111 determines whether the user selects a peripheral device performing the operation corresponding to the operation information. If it is determined that the peripheral device is selected, the operation-history-information-control unit 111 advances to step S804. If it is determined that the peripheral device is not selected, the operation-history-information-control unit 111 advances to step S807.

At step S804, the operation-history-information-control unit 111 acquires detailed information about an executable function from the selected peripheral device via the network I/F 114, for example. Next, at step S805, the operation-history-information-control unit 111 displays the detailed function information acquired at step S804 on the display unit 113 via the output-control unit 107 or the like (the detailed function information may be displayed in list form). For example, when the above-described function is the printing function, the operation-history-information-control unit 111 acquires information about the display size, the print size, etc., that is, detailed information about function from the peripheral device selected by the user, and displays the acquired information on the display unit 113. Then, the operation-history-information-control unit 111 receives input information (and/or operation information) that is related to setting of the display size, the print size, etc. and that is transmitted from the user via the input unit 112.

At step S806, the operation-history-information-control unit 111 determines, for example, whether (the display size, the print size, etc. are set, and) the execution button 603 or the like shown in FIG. 6 is pressed down based on the operation information or the like transmitted from the user via the input unit 112. If it is determined that (the setting is performed and) the execution button 603, etc. shown in FIG. 6 is pressed down, the operation-history-information-control unit 111 advances to step S807. If it is determined that the execution button 603, etc. is not pressed down, the operation-history-information-control unit 111 performs the processing corresponding to step S806 again.

At step S807, the operation-history-information-control unit 111 transmits an operation command relating to an operation selected by the user to the peripheral device selected by the user via the network I/F 114.

Here, the operation-history-information-control unit 111 may automatically switch between exhibition (display) and unexhibition (non-display) of the operation-history information according to the peripheral device selected by the user. In that case, the operation-history-information-control unit 111 automatically switches between the exhibition (display) and the unexhibition (non-display) of the operation-history information according to information about a peripheral device that does not exhibit the operation-history information stored in (and/or set to) the HD 105.

Further, according to the security level set to operation-target-file data, the operation-history-information-control unit 111 may automatically switch between exhibition and unexhibition relating to operation-history information about the operation-target-file data and operation-history information about a group to which the operation-target-file data belongs. Namely, if the security level set to the operation-target-file data is higher than a security level which is set in advance, the operation-history-information-control unit 111 does not exhibit the operation-history information about the operation-target-file data. On the other hand, if the security level set to the operation-target-file data is lower than the security level which is set in advance, the operation-history-information-control unit 111 exhibits the operation-history information about the operation-target-file data.

Further, on the basis of information (storage-acceptance/rejection information) about the attribute and/or type of file data of which operation-history information is not automatically stored, the information being set by the user, the operation-history-information-control unit 111 may switch between automatic storage and non-storage of the operation-history information. Here, the storage-acceptance/rejection information set by the user is stored in the HD 105, etc.

Further, on the basis of information about an operation item or the like for which operation-history information is not automatically exhibited (unexhibited-operation-item information), the information being set by the user, the operation-history-information-control unit 111 may not automatically exhibit the operation-history information depending on an operation item selected by the user. Here, the unexhibited-operation-item information set by the user is stored in the HD 105, etc.

Further, the operation-history-information-control unit 111 may exhibit operation-history information based on exhibition-combination information relating to the operation-history information, the exhibition-combination information being set by the user. The exhibition-combination information set by the user is stored in the HD 105, etc. Here, the exhibition-combination information relating to the operation-history information denotes information about a combination of file-data-group information exhibited as the operation-history information (and/or the reduced image of file data belonging to file-data group relating to selected file data) and operation information.

For example, when an operation relating to printing is performed, the user can determine that the file-data-group information is exhibited, for example, as the exhibition-combination information even though the operation information is not exhibited as the operation-history information. When the exhibition-combination information is set in the above-described manner and the operation item denotes printing operation, the information-processing apparatus 101 does not exhibit the operation information as the operation-history information about selected file data, but exhibits the file-data-group information only. In the second embodiment, the exhibition-combination information is set according to printing (that is, the operation item), for example. However, the exhibition-combination information may be set according to the security level, etc. of the peripheral device and the file data.

Thus, according to the second embodiment, the operation corresponding to the operation information included in the operation-history information can be re-executed for the file-data group exhibited as the operation-history information. Further, if the user wishes to reuse only part of the operation information, the operation information for reuse can be easily reset, which increases the convenience of the user.

Further, according to the second embodiment, it becomes possible to switch between exhibition and unexhibition of the operation-history information according to the security level of the peripheral device and the file data, the operation item, etc. Still further, it becomes possible to switch between storage and nonstorage of the operation-history information according to information about the attribute, type, etc. of the file data. Still further, it becomes possible to determine to exhibit and/or unexhibit the file-data-group information and the operation information as the operation-history information.

### Third Embodiment

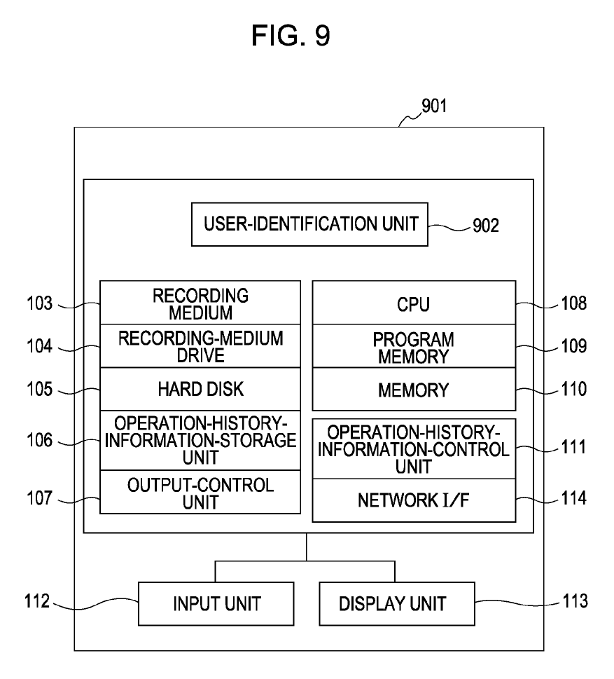

FIG. 9 is a block diagram showing the configuration of an information-processing apparatus 901 including a PC, a computer, etc. The information-processing apparatus 901 further includes a user-identification unit 902 in addition to the same components as those of the information-processing apparatus 101 shown in FIG. 1 described in the first embodiment.

The user-identification unit 902 may identify a user based on log-in information including identification (ID), a password, etc. input by the user through the input unit 112, or information obtained through finger-print authentication, etc.

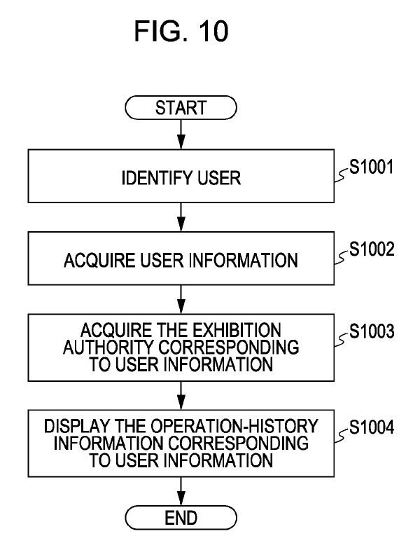

FIG. 10 is a flowchart showing example operations performed to display the operation-history information according to information about the user identified by the user-identification unit 902. At step S1001, the user-identification unit 902 identifies a user who currently uses the information-processing apparatus 901. Next, at step S1002, the operation-history-information-control unit 111 acquires information about the user identified at step S1001 (user information).

The user information is determined and registered with the HD 105, etc. in advance. The user information includes information about authority and/or a password that are set for every user. The user information may include information relating to disclosure of the operation-history information to a different user.

Next, at step S1003, the operation-history-information-control unit 111 acquires information about the authority to exhibit the operation-history information of the acquired user information (exhibition authority) and generates the operation-history information corresponding to the exhibition authority.

Next, at step S1004, the operation-history-information-control unit 111 displays the generated operation-history information on the display unit 113 via the output-control unit 107. Here, the information-processing apparatus 901 also stores the user information at the operation-history-information-storage time. Subsequently, when the operation-history information is exhibited later, information showing which user performed the operations shown in the operation-history information may also be exhibited simultaneously.

Further, the information-processing apparatus 901 may not identify users individually. Namely, the information-processing apparatus 901 may identify users by classifying the users as an ordinary user, an administrator user, etc. so that restricted operation-history information is exhibited to the ordinary user and the entire operation-history information is exhibited to the administrator user.

As described above, according to the third embodiment, it becomes possible to switch between display and non-display of information for reuse depending on the user type. Therefore, it becomes possible to use the information for reuse even though the information includes operation information and/or operation-target data which should be hidden from other users.

### Other Embodiments

It is to be understood that the object of the present invention can also be achieved by supplying a storage medium (and/or a recording medium) storing program code of software for implementing the functions of the above-described embodiments to a system and/or an apparatus so that a central-calculation unit (a CPU and/or an MPU) of the system and/or the apparatus reads and executes the program code stored in the storage medium. In that case, the program code itself, read from the storage medium, achieves the functions of the above-described embodiments, and thus the storage medium storing the program code constitutes the present invention.

Further, when the central-calculation unit of the system and/or the apparatus executes the read program, an operating system (OS) or the like running on the system and/or the apparatus executes part of and/or the entire practical processing according to instructions of the program code so that the functions of the above-described embodiments are achieved, which constitutes another embodiment of the present invention.

Further, after the program code read from the storage medium is written in a memory of a function-expansion card inserted into the system and/or the apparatus, and/or a function-expansion unit connected to the system and/or the apparatus, a CPU or the like of the function-expansion card and/or the function-expansion unit executes part of and/or the entire practical processing so that the functions of the above-described embodiments are achieved, which constitutes another embodiment of the present invention.

When using the present invention for the above-described storage medium, the storage medium stores the program code corresponding to the above-described flowcharts.

Thus, according to each of the above-described embodiments, when a file-data item is selected from among file-data items for which operations are performed, it becomes possible to easily reuse a combination of file-data items other than the selected file-data item even though the user does not explicitly stores information about the history of the selected file-data item.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions. The disclosed exemplary embodiments may be arbitrarily performed in combination.

This application claims the benefit of Japanese Application No. 2007-106135 filed on Apr. 13, 2007, which is hereby incorporated by reference herein in its entirety.

What is claimed is:

1. An apparatus comprising:
an operation-history-information-storage unit configured to generate operation-history information including content-group information relating to a content group and operation information relating to the content group, and store the operation-history information in a storage unit;
a determination unit configured to determine, when a content is selected, whether the operation-history information stored in the storage unit includes operation-history information including content-group information relating to a group including the selected content; and
a display unit configured to display a GUI component including the content-group information included in the operation-history information and the operation information when the determination unit determines that the operation-history information including the content-group information relating to the group including the selected content exists.

2. The apparatus according to claim 1, wherein the display unit displays the GUI component further including a button relating to execution of the operation information, further comprising a re-execution unit configured to execute processing relating to re-execution of the operation information for the content group relating to the content-group information according to a selection operation input via the button.

3. The apparatus according to claim 1, wherein the display unit displays the GUI component further including a button used to reselect the content.

4. The apparatus according to claim 1, wherein the display unit displays the GUI component further including a button used to reset the operation information.

5. The apparatus according to claim 1, further comprising a user-identification unit,
wherein the operation-history-information-storage unit further stores information about a user identified by the user-identification unit, and
wherein the display unit displays the operation-history information according to the user information.

6. The apparatus according to claim 5, wherein the user information includes exhibition-authority information relating to disclosure of the operation-history information for a different user, and
wherein the display unit displays the operation-history information according to the exhibition-authority information.

7. A method comprising:
generating operation-history information including content-group information relating to a content group and operation information relating to the content group, and storing the operation-history information in a storage unit;
determining, when a content is selected, whether the operation-history information stored in the storage unit includes operation-history information including content-group information relating to a group including the selected content; and
displaying a GUI component including the content-group information included in the operation-history information and the operation information when it is determined that the operation-history information including the content-group information relating to the selected group including the content exists.

8. The method according to claim 7, wherein the GUI component further including a button relating to execution of the operation information is displayed, further comprising performing re-execution to execute processing relating to re-execution of the operation information for the content group relating to the content-group information according to a selection operation input via the button.

9. The method according to claim 7, wherein the GUI component further including a button used to reselect the content is displayed.

10. The method according to claim 7, wherein the GUI component further including a button used to reset the operation information is displayed.

11. The method according to claim 7, further comprising performing user identification,
wherein information about a user identified through the user-identification is stored, and
wherein the operation-history information is displayed according to the user information.

12. The method according to claim 11, wherein the user information includes exhibition-authority information relating to disclosure of the operation-history information for a different user, and
wherein the operation-history information is displayed according to the exhibition-authority information.

13. A computer-readable-storage medium storing instructions which, when executed by an apparatus, causes the apparatus to perform operations comprising:
generating operation-history information including content-group information relating to a content group and operation information relating to the content group, and storing the operation-history information in a storage unit;
determining, when a content is selected, whether the operation-history information stored in the storage unit includes operation-history information including content-group information relating to a group including the selected content; and
displaying a GUI component including the content-group information included in the operation-history information and the operation information when it is determined that the operation-history information including the content-group information relating to the group including the selected content exists.
